(19) United States
(12) Patent Application Publication
(10) Pub. No.: US 2026/0010814 A1
(43) Pub. Date: Jan. 8, 2026

(54) MINIMAL SUPERCONDUCTING QUANTUM CIRCUIT FOR BOSONIC CODES WITH GALVANIC COUPLING

(71) Applicant: ALICE & BOB, Paris (FR)

(72) Inventors: Antoine ESSIG, Paris (FR); Raphaël LESCANNE, Paris (FR); Sébastien JEZOUIN, Paris (FR)

(21) Appl. No.: 19/134,634

(22) PCT Filed: Dec. 6, 2023
(86) PCT No.: PCT/EP2023/084629

§ 371 Date: May 30, 2025

(30) Foreign Application Priority Data
Dec. 7, 2022 (EP) 22306816.4

(51) Int. Cl. G06N 10/40; G06N 10/70

(52) U.S. Cl. CPC G06N 10/40; G06N 10/70

(57) ABSTRACT

A non-linear superconducting quantum circuit (circuit) comprises a resonant portion and an asymmetrical threaded superconducting quantum interference device (ATS), connected galvanically, and which implements first and second modes with respective resonant frequencies, wherein the ratio between the resonant frequencies is different by 1/2. The resonant portion has a symbolic representation comprising a linear resonant portion implemented with an inductor and a capacitor, and a non-linear resonant portion implemented with a capacitor and the ATS, wherein the linear and non-linear resonant portions are connected galvanically and are arranged such that one has elements connected in series, and the other has elements connected in parallel. The resonant portion is configured with inductance and capacitance values which induce, with the ATS, the first and second modes such that the circuit has zero-point fluctuations of the superconducting phase across the ATS for the first and second modes at or above 0.05 rad.

### CROSS-REFERENCE TO RELATED APPLICATIONS

This present application is a national stage application of International Patent Application No. PCT/EP2023/084629, filed Dec. 6, 2023, which claims priority to European Patent Application No. EP22306816.4, filed Dec. 7, 2022, the disclosures of which are hereby incorporated by reference in their entireties.

### TECHNICAL FIELD

The present disclosure pertains to the field of superconducting quantum circuits, and more specifically, to superconducting quantum circuits including a cat qubit.

### BACKGROUND

Cat qubits are a subset of bosonic codes, which form a family of error correction codes for quantum applications. Generally speaking, bosonic codes rely on storage of the qubits in bosonic modes. In the case of cat qubits, a 2-component cat code has been the most common design to date.

The dissipative stabilization of two coherent states utilizes an engineering of a non-linear conversion between two photons of a first mode that hosts the stabilized quantum manifold, wherein the first mode is also called a cat qubit mode, and one photon of a second mode, which is known as buffer mode, and conversely. Such a stabilization scheme allows for an exponential suppression of bit-flips with the number of photons in the two coherent states. However, this stabilization scheme is effective when the confinement rate of the two coherent states is larger than escape rates that are induced by external sources of noise. The confinement rate is directly related to the 2-to-1 photon conversion rate.

First implementations of this stabilization scheme (Leghtas et al., Science 347, 853 (2015) “Confining the state of light to a quantum manifold by engineered two-photon loss” and Touzard et al., Physical Review X 8, 021005 (2018) “Coherent Oscillations inside a Quantum Manifold Stabilized by Dissipation”) were unsuccessful in observing the exponential suppression of bit-flips because the superconducting circuit element used to engineer the 2-to-1 photon conversion, a so-called transmon, has spurious cross-Kerr terms which induce additional noise processes with escape rates given by the very large transmon-cat-qubit dispersive shift. The article “Exponential suppression of bit-flips in a qubit encoded in an oscillator”, Lescanne R. et. Al., Nature Physics, 2020) (hereinafter “Lescanne 2020”) disclosed a much improved cat qubit by using an asymmetrical threaded superconducting quantum interference device (also referred to as “ATS”) to engineer the 2-to-1 photon conversion. The ATS design has much lower cross-Kerr terms than the transmon, which allowed for the observation of the exponential suppression of bit-flips. However, a transmon was also used to measure the cat qubit state. Though less harmful to the cat qubit in this position, it still results in a saturation of the bit-flip time to a few milliseconds. A later work by Berdou et. al. in the article “One hundred second bit-flip time in a two-photon dissipative oscillator”, arXiv: 2204.09128, https://arxiv.org/pdf/2204.09128.pdf (hereinafter “Berdou 2022”) succeeded at increasing the bit-flip saturation time by 5 order of magnitudes, up to 100 seconds, by removing the measuring transmon and operating the ATS in a regime where it is supposed to be dynamically stable. This tremendous increase in the bit-flip time was possible because the ATS alone adds spurious noise processes with very low escape rates. However, the confinement rate achieved in Berdou 2022 was very low.

The ratio of the confinement rate to the phase-flip rate of the cat qubit is the fundamental metric of quantum error correction with cat qubits. On the one hand, the confinement rate tells how strongly the cat qubit can be perturbed without experiencing a bit-flip, which is directly related to how fast a gate can be performed while preserving exponential suppression of bit-flips. On the other hand, the phase-flip rate tells in how much time one should perform the gates in order to allow for detection and correction of errors. Theoretical analysis suggest that this ratio should be larger than 10⁴. In Lescanne 2020 and Berdou 2022, this ratio is respectively 10 and 0.01.

At the time of writing, no other circuit is known which provides a well performing cat qubit. The average stability lifetime of the other known cat qubits are no better than a few milliseconds, which is insufficient for building quantum circuits which can be practically used. Since the confinement rate is directly related to the engineered 2-to-1 photon conversion rate, a massive increase of the later is required in ATS-based circuits.

### SUMMARY

The present disclosure overcomes these challenges. To this end, a non-linear superconducting quantum circuit is described, which comprises at least one resonant portion and an asymmetrical threaded superconducting quantum interference device connected galvanically, said non-linear superconducting quantum circuit having a first mode with a first resonant frequency and a second mode with a second resonant frequency, the ratio between said first resonant frequency and said second resonant frequency being different from 1/2, said at least one resonant portion having a symbolic representation comprising a linear resonant portion comprising at least one inductance and at least one capacitor and a non-linear resonant portion comprising at least one capacitor and said asymmetrical threaded superconducting quantum interference device. Said linear resonant portion and non-linear resonant portion is connected galvanically and arranged respectively such that one has its elements connected in series, and the other one has its elements connected in parallel, said at least one resonant portion being configured with inductance and capacitance values which induce with said asymmetrical threaded superconducting quantum interference device said first mode and said second mode such that said non-linear superconducting quantum circuit has zero-point fluctuations of the superconducting phase across the asymmetrical threaded superconducting quantum interference device for the first mode and the second mode which are superior or equal to 0.05 rad.

This superconducting quantum circuit is advantageous because it has no coupling element which would reduce the participation of the buffer and/or memory modes in the ATS, hence the 2-to-1 photon conversion rate. In theory, it could be possible to minimize the detrimental impact of the coupling capacitor in the circuit of Lescanne 2020, but large capacitors are known to be lossy in superconducting circuits, which would increase the phase-flip rate, and thus render its application ineffectual in real-life implementation. Furthermore, this design contains the least elements possible, which minimizes the risks in terms of industrialization cost and feasibility.

In various embodiments, the method may present one or more of the following features:
said linear portion comprises elements arranged in parallel and said non-linear portion comprises elements arranged in series;
said linear resonant portion comprises elements arranged in series and said non-linear resonant portion comprises elements arranged in parallel;
said non-linear superconducting quantum circuit lies on a dielectric substrate and is delimited from a common ground plane by exposed portions of said dielectric substrate, and said linear resonant portion and said non-linear resonant portion are realized in physically distinct portions of said non-linear superconducting quantum circuit;
said non-linear superconducting quantum circuit is formed on a substantially planar substrate and has a width and a height which are shorter than the quarter wavelength corresponding respectively to said first resonant frequency and said second resonant frequency,
said non-linear resonant portion and said linear resonant portion are galvanically connected to said common ground plane;
said non-linear resonant portion and said linear resonant portion are galvanically isolated from said common ground plane;
said non-linear superconducting quantum circuit lies on a dielectric substrate and is delimited from a common ground plane by exposed portions of said dielectric substrate, and said at least one resonant portion is realized into a transmission line;
the first mode and the second mode are respective fundamental or higher order harmonics of said non-linear superconducting circuit;
the first resonant frequency and the second resonant frequency are such that the difference between two times the first resonant frequency and the second resonant frequency is smaller than half the first resonant frequency and half the second resonant frequency; and
said at least one inductance and/or said transmission line is made by an array of Josephson junctions or a high kinetic inductance material.

The present disclosure also pertains to a quantum device comprising a non-linear superconducting quantum circuit according to embodiments herein, a first microwave source connected to said at least one resonant portion for providing a radiation having a frequency equal to said second resonant frequency, a second microwave source connected to said at least one resonant portion for providing a radiation having a frequency equal to the difference between two times the first resonant frequency and the second resonant frequency, and a load coupled to said at least one resonant portion such that specifically the second mode is coupled to said load, said first mode thereby hosting a cat qubit. The device may further comprise a microwave filter for coupling to said load, said microwave filter being arranged to let the second resonant frequency pass and to block the first resonant frequency.

The present disclosure also pertains to a quantum computing system comprising at least one device, according to the embodiments described herein.

### BRIEF DESCRIPTION OF THE DRAWINGS

Other features and advantages of the present disclosure are readily available in the following description of the drawings, which show exemplary embodiments, and on which:

FIG. 1 illustrates how a galvanic cat qubit circuit is incorporated in a device to stabilize quantum information;

FIG. 2 illustrates how to use the galvanic cat qubit circuit incorporated in a device to stabilize quantum information;

FIG. 3 represents an electrical equivalent diagram of a first embodiment of a galvanic cat circuit, according to some embodiments;

FIG. 4 shows a diagram illustrating values of o for respectively the first mode and the second mode of the superconducting quantum circuit of FIG. 3, along with corresponding g₂/φₚ values;

FIG. 5 represents a realization of the circuit of FIG. 3;

FIG. 6 represents an electrical equivalent diagram of a second embodiment of a galvanic cat circuit according to some embodiments;

FIG. 7 shows a diagram illustrating values of o for respectively the first mode and the second mode of the superconducting quantum circuit of FIG. 6 along with corresponding g₂/φₚ values;

FIG. 8 represents a realization of the circuit of FIG. 6;

FIG. 9 represents a third embodiment of the galvanic cat circuit;

FIGS. 10A, 10B, and 10C represent graphs depicting the behavior of the circuit of FIG. 9 as the length of the transmission line varies; and

FIG. 11 shows the ratio of the square of the zero-point fluctuations of the phase of modes b and a in the linear capacitors and inductor of the first embodiment, in complement to FIG. 4.

### DETAILED DESCRIPTION

The drawings and the following description are comprised for the most part of positive and well-defined features. As a result, they are both useful in understanding the present disclosure, and can also be used to contribute to its definition, should the need arise.

For a cat qubit to encode useful data and be stabilized, a 2-to-1 photon conversion needs to occur between a first mode (the memory) and a second mode (the buffer). Most of the existing prior art belongs to a family of cat qubits stabilized by parametric pumping dissipation. Parametric pumping dissipation techniques are used to bridge the gap between the frequencies of the two modes and perform the resonant 2-to-1 photon conversion when the second mode does not have a resonant frequency which is a multiple of 2 of the resonant frequency of the first mode. In other words, the external time-varying excitation used in parametric pumping dissipation relaxes the constraint on the resonant frequencies.

The first mode and the second mode of the superconducting quantum circuit may each correspond to natural resonance frequencies of the circuit. For example, each of the first mode and the second mode are an electromagnetic mode. Each of the first mode and the second mode may have a respective resonant frequency, e.g., the first mode may have a resonant frequency of the type

$${f}_{a} = \frac{{ω}_{a}}{2 π}$$

and the second mode may have a resonant frequency of the type

$${f}_{b} = \frac{{ω}_{b}}{2 π} ,$$

where ωₐ and ω_{b} may be the angular frequencies of each respective mode. By “having” a first mode and a second mode, it is meant that the superconducting quantum circuit may comprise components operating in a superconducting regime which host the modes independently of each other or concurrently. In other words, the first mode and the second mode may be hosted in different subsets of components of the superconducting circuit or on the same subset of components.

The superconducting quantum circuit may be operated at temperatures close to absolute zero (e.g., 100 mK or less, typically 10 mK), and isolated as much as possible from the environment to avoid energy loss and decoherence, except for some tailored couplings. For example, specifically the second mode may be coupled to a dissipative environment, while the first mode may remain isolated from the environment.

The superconducting quantum circuit may be manufactured as one or more patterned layers of superconducting material (e.g., aluminum, tantalum, niobium among others, as known in the art) deposited on a dielectric substrate (e.g., silicon., sapphire among others). Each of the one or more patterned layers may define lumped element resonators. A capacitive element may be formed (on a respective layer of the one or more patterned layers) with two neighboring plates of superconducting material. An inductive element may be formed with a superconducting wire. Alternatively, at least one of the one or more patterned layers may define portions of transmission lines each resonating at a frequency which depends on their length. The transmission lines may be, for example, co-planar wave guides, slotlines or microstrip lines. Yet alternatively, the circuit may be embedded in a 3D architecture which comprises high quality 3D modes machined or micro-machined into bulk superconductor that can be used as any of the two modes.

The circuit may be integrated into a device which may comprise a load, a first microwave source, a second microwave source and a coupler. The coupler may be configured to connect the second mode of the superconducting quantum circuit to the load. The load is a dissipative element, e.g., an element with a given resistance—as opposed to a superconducting element—that is external to the superconducting circuit. The load dissipates pairs of photons converted from the first mode to the second mode through the 2-to-1 photon conversion. In other words, pairs of photons destroyed from the first mode are evacuated through the second mode via the load to the environment. The first microwave source may be configured to control the microwave radiation in amplitude and phase so as to apply a microwave radiation at a frequency substantially equal to the frequency of the second mode. The first microwave source thus drives photons in the form of the microwave radiation into the second mode which, in turn, drives pairs of photons in the first mode through the 2-to-1 photon conversion. This 2-to-1 photon conversion is reciprocal: it can conversely be 2 photons of the first mode to 1 photon of the second mode or 1 photon of the second mode to 2 photons of the first mode. The coupler is an element which may be connected galvanically, capacitively, or inductively to elements of the circuit hosting the second mode and which mediates the interaction between the second mode, the load and the microwave source.

The load may be a resistor, a matched transmission line, or a matched waveguide. The expression “matched” should be interpreted as meaning that the transmission line or the waveguide are terminated by a resistance at an end different from the end connected to the elements hosting the second mode, the value of such resistance being chosen such that the power going towards the load is mostly absorbed. The load may be comprised within the first microwave source.

In various examples, the first microwave source may be placed at room temperature and connected to the circuit via coaxial cables. In various examples, attenuators may be placed between the microwave source and the circuit—that is, along the path of the microwave radiation applied by the microwave source—to thermalize the microwave radiation with the cryogenic environment. This allows for the application of the microwave radiation without added thermal noise.

The second microwave source is used to provide microwave radiation at a frequency substantially equal to two times the resonant frequency of the first mode minus the resonant frequency of the second mode, so as to obtain the 2-to-1 photon conversion. Since the ATS has two superconducting loops which must be flux-pumped with adequate relative amplitude and phase, the radiation emitted by the second microwave source may be split to feed two different transmission lines or waveguides connected in the end to the two superconducting loops. Alternatively, two different microwave sources emitting signal at the same frequency as the second microwave source may be used to feed directly the two transmission lines or waveguides with adequate relative amplitude and phase.

Optionally, the device may comprise a microwave filter connected to the first mode and the second mode of the circuit. The microwave filter may be configured to specifically allow the coupling of the second mode to the load. This microwave filter may be interleaved between the load and the coupler. From the point of view of the circuit, this filter aims at preventing the microwave photons in the first mode from escaping the circuit. This can either be done by realizing a band stop filter at the first resonant frequency, or by realizing a bandpass filter at the second resonant frequency, or by realizing a high-pass (respectively low-pass) filter with a cutoff frequency in between the first and second resonant frequencies if the second (respectively first) resonant frequency is larger than the first (respectively second) resonant frequency, as the photon of the second mode are the ones that are being configured to dissipate into the environment. For some circuits, for instance when the two modes have different symmetries, the filter may not be necessary, and the proper position of the coupler in the circuit may be sufficient to prevent the dissipation of the first mode.

Thus, the device enables the stabilization of two coherent states in the first mode, that is, a quantum manifold of coherent states. For example, the first microwave source applying the microwave radiation to the second mode through the microwave filter may be seen as a 2-photon drive of the first mode once converted by the 2-to-1 photon conversion, and the load that dissipates photons of the second mode may be seen as a 2-photon dissipation of the first mode once converted by the 2-to-1 photon conversion. The 2-photon drive and 2-photon dissipation enables the stabilization of two coherent states in the first mode.

The single photon drive on the second mode is formally described by the Hamiltonian H_{b}=ℏϵ_{b}b^{†}+ℏϵ_{b}*b where ϵ_{b} is the single photon drive rate on the second mode due to the first microwave source. The single photon dissipation on the second mode is formally described by the Lindblad operator L_{b}=\sqrt{k_{b}}b where kₚ is the single photon dissipation resulting from the coupling of the second mode to the load.

The 2-photon drive is formally described by the Hamiltonian

$${H}_{2} = {ℏϵ}_{2} {a}^{† 2} + {ℏϵ}_{2} {a}^{2}$$

where ϵ₂ is the effective 2-photon drive rate. The 2-photon loss is formally described the Lindblad operator

$${L}_{2} = \sqrt{{κ}_{2}} {a}^{2}$$

where k₂ is the 2-photon dissipation rate. The amplitude α of the stabilized coherent states is finally given by

$$a = {( \frac{2 {ϵ}_{2}}{{κ}_{2}} )}^{1 / 2} .$$

The confinement rate of the coherent states is

$${κ}_{conf} = {κ}_{2} {α}^{2} .$$

In the regime k_{b}>>g₂α where g₂ is the 2-to-1 non-linear conversion rate between the first mode and the second mode, the buffer dynamics can be adiabatically eliminated, which yields ϵ₂=2ϵ_{b}g₂/k_{b} and

$${κ}_{2} = 4 {g}_{2}^{2} / {κ}_{b} .$$

In various examples, the superconducting circuit may have a symbolic representation, e.g., consisting of a set of interconnected dipoles. The expression “symbolic representation” should be interpreted as designating an arrangement of symbols and lines which specify a set of interconnected dipoles. The set of interconnected dipoles (also called components) forms a circuit structure (or topology) equivalent (in functioning) to the non-linear superconducting circuit.

In other words, and as is classical in the field of superconducting circuits, the non-linear superconducting circuit is configured to achieve the functioning defined by its symbolic representation. in other words the functioning of the theoretical set of interconnected dipoles shown by the symbolic representation. Yet again in other words, while the circuit may be constructed using a patterned layer of superconducting material, it is to be understood that the circuit admits a symbolic representation by dipoles, for example, capacitors, inductors, and/or Josephson junctions. While the example dipoles describe discrete elements, it should be understood that these elements correspond to the equivalent circuit of distributed elements in a specific frequency range, e.g., at low frequency.

Such distributed elements may also have higher frequency modes which are irrelevant for the dynamics described herein. Hence, these distributed elements may be represented with the symbolic representation for ease of discussion herein. This symbolic representation may be refined by adding elements such as series inductors with each wire connection or a parallel capacitor between any two nodes of the circuit or adding nodes and branches to take into account other modes of the distributed elements. Thus, the symbolic representation allows for a better description of the distributed elements without changing the working principle of the circuit. Hence, the physical circuit-that is the circuit which is actually manufactured-and its symbolic representation are considered equivalent. Indeed, the refining dipoles of the symbolic representation specifically adjust the resonance frequencies or the zero-point fluctuation of the phase compared to the basic model. When designing the circuit, the final geometry may be fully and accurately simulated with a finite element solver, which will readily give the frequencies of the modes, the dissipation originating from the loads, and the zero-point fluctuation of the phase across the Josephson junctions, which are the unknowns when computing the 2-to-1 photon conversion rate in any configuration.

The 2-to-1 photon interaction Hamiltonian is of the form

$$\frac{{H}_{2}}{ℏ} = {g}_{2} ( t ) {a}^{2} {b}^{†} + h . c .$$

In these cases, the coupling term g₂(t) is modulated via the parametric pump, where the pump injects an external time-varying parameter having a frequency ωₚ=2ωₐ-ω_{b}. The parametric pump is used in the prior art to render the non-linear interaction resonant.

The development of cat-qubit quantum circuit relies on superconducting circuit geometries, which are configured to allow for the suppression of the bit-flips of a cat qubit encoded in a high-Q superconducting resonator, called the memory. For this purpose, a two-photon dissipation of the memory is engineered by coupling it to a low-Q superconducting resonator, called the buffer, through a non-linear superconducting dipole.

In the article Lescanne 2020, the non-linear Hamiltonian H2 is engineered with an ATS superconducting dipole. The ATS dipole has the following potential energy:

U(φ)=0.5*E_{L}*φ²-2*Eⱼ cos(φ_{σ})*cos(φ-φ_{δ}), where E_{L} is the Josephson energy of the ATS shunt inductance, Eⱼ is the Josephson energy of the ATS SQUID junctions, φ_{σ} (respectively φ_{δ}) is the magnetic flux threading the common (respectively differential) loop modes of the ATS.

By choosing the following DC values of the magnetic fluxes, known as the saddle point: |φ_{σ,DC}|=|φ_{δ,DC}|=π/2, and flux pumping specifically the sigma mode with an amplitude φₚ and frequency φₚ, the potential energy becomes:

$$U ( φ ) = 0.5 * {E}_{L} * {φ}^{2} - 2 * {E}_{J} * sin ( {φ}_{p} cos ( {ω}_{p} t ) ) * sin ( φ )$$

The phase φ across the ATS is related to the modes a and b by:

$$φ = {φ}_{a} ( a + {a}^{†} ) + {φ}_{b} ( b + {b}^{†} )$$

Where φₐ and φ_{b} are the zero-point fluctuations of the phase across the ATS of the first and second resonant mode, respectively. Expanding U(φₐ(a+a^{†})+φ_{b}(b+b^{†})) at third order in φₐ and φ_{b} and eliminating fast rotating terms yields the 2-to-1 conversion Hamiltonian H₂ with the 2-to-1 photon conversion rate

$${g}_{2} = 0.5 * {E}_{j} * {φ}_{a}^{2} * {φ}_{b} * {φ}_{p} .$$

The article Lescanne 2020 demonstrated that bit-flips are exponentially suppressed with the number of photons α² of a cat qubit encoded in a resonator. However, this architecture uses a transmon coupled to the cat qubit as a measurement apparatus, which results in a bit-flip time saturating to a few milliseconds. This is due to the confinement rate being too small to resist to dispersive frequency shifts induced by the thermal excitations of the measurement apparatus. Later work by the Applicant, disclosed in the article Berdou 2022, increased the bit-flip saturation time by 5 orders of magnitude by removing the transmon and operating the ATS in a regime where it is supposed to be dynamically stable, despite an even lower confinement rate. More precisely, in the article Lescanne 2020, the ratio of the confinement rate to phase-flip rate is 10, whereas in Berdou 2022, this ratio is 0.01. As explained in the introductory part of the present application, such ratios are very far from the theoretically needed values.

The main problem with Lescanne 2020 and Berdou 2022 is that they offer no potential solution to significantly increase the two-photon dissipation rate. Indeed, the two-photon dissipation rate is related to the two-photon coupling rate

$${g}_{2} = 0.5 * {E}_{j} * {φ}_{a}^{2} * {φ}_{b} * {φ}_{p} .$$

In the articles Lescanne 2020 and Berdou 2022, the buffer mode is localized on the ATS and the memory mode is weakly coupled capacitively to the buffer mode, hence to the ATS. This design allows one to make large φ_{b}, but φₐ is typically one to two orders of magnitude smaller. Since the formula of g₂ depends on the square of φₐ, this circuit geometry is very detrimental to the strength of the two-photon dissipation.

The primary way to circumvent this problem is to sufficiently increase the capacitance coupling the memory and buffer modes of the circuits of Lescanne 2020 and Berdou 2022 to have the ATS participate strongly in both the buffer and memory modes. However, large capacitors are known to be lossy in superconducting circuits.

These prior arts are thus dead ends: their specific geometry is crucial to achieving the bit-flip stabilization, but it cannot be tweaked to allow for a large enough two-photon dissipation rate.

Examples and illustrations of the circuit and device, according to the embodiments herein, are now discussed with reference to the figures. In the following, the expression “galvanic cat qubit circuit”, “circuit”, “superconducting quantum circuit” and “non-linear superconducting circuit” are interchangeable and designate the circuit performing the 2-to-1 photon conversion allowing to stabilize the cat qubit.

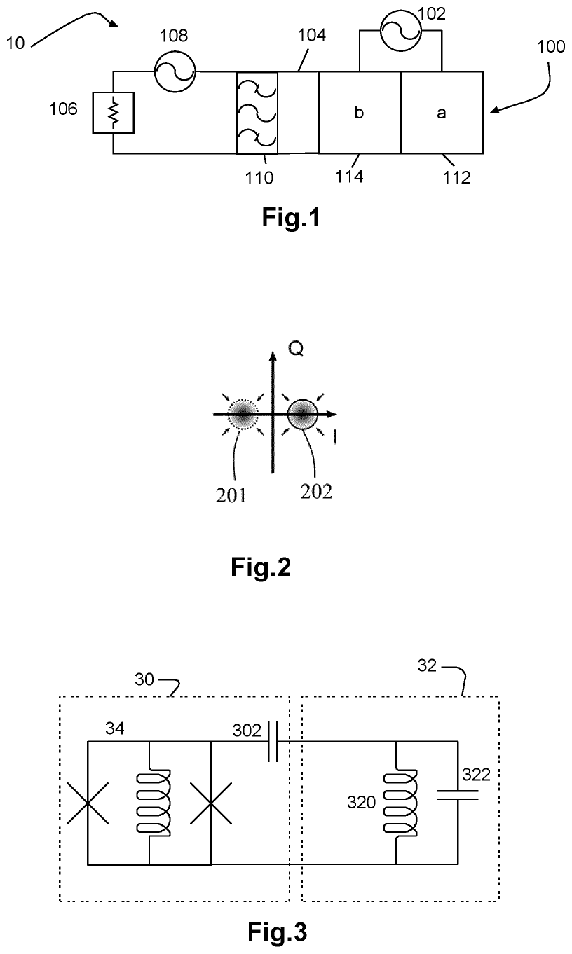

FIG. 1 shows an example of a quantum device 10 comprising a galvanic cat qubit circuit, according to some embodiments.

The device 10 comprises a non-linear superconducting circuit 100, a microwave source 102, a coupler 104, a load 106, another microwave source 108, and a microwave filter 110.

The non-linear superconducting circuit 100 performs the 2-to-1 photon conversion between a first mode a referenced 112 and a second mode b referenced 114. In the following, first mode a hosts a cat qubit, which is also known as the memory mode, whereas second mode b is used as a buffer in between the cat qubit and the environment.

Device 10 uses parametric pumping to stabilize the cat qubit, which means that the resonance frequencies of the first mode and the second mode are not of the type 2fₐ=f_{b}. In order to ensure the 2-to-1 photon conversion, a parametric pump provides radiation at a frequency of 2fₐ-f_{b}. This is performed by microwave source 102 which is connected to the non-linear superconducting circuit 100.

As additionally described below; the non-linear superconducting circuit 100 is specific in that it comprises an ATS (“Asymmetrical threaded SQUID” or “Asymmetrical threaded Superconducting quantum interference device”), which is galvanically coupled to the other elements of the non-linear superconducting circuit 100 hosting both modes a and b.

The components of the circuit hosting the second mode 114 are coupled via coupler 104 to the load 106. This coupling renders the second mode as dissipative. The microwave source 108 is connected to the non-linear superconducting circuit 100 and is used to drive the second mode at its resonance frequency by emitting a radiation at frequency f_{b}. The microwave filter 110 is herein configured as a bandpass filter with a frequency f_{b}. Alternatively, the filter 110 may be configured as a band stop filter at a frequency fₐ, and may be placed in between the environment and the two modes to isolate the first mode and thus prevent the first mode from suffering additional losses coming from unwanted coupling to the load 106. Alternatively, if may be configured as a low-pass (respectively high-pass) filter if fₐ>f_{b} (resp f_{b}>fₐ). In other embodiments, the microwave filter 110 can be omitted when coupling between the load 106 and the second mode can be established.

FIG. 2 illustrates the stabilization a quantum manifold of coherent states of the first mode achieved by the 2-to-1 photon conversion performed by the circuit 100.

This figure illustrates the Wigner function of a first mode undergoing a two-photon drive with rate ϵ₂ and two-photon dissipation with rate k₂ that has two stable steady states (201, 202) of amplitude α=√2ϵ₂/k₂ and with opposite phase. Since there are two possible states, one can encode information: the state |0> 202 is circled with a solid line and the state |1> 201 with a dotted line. This encoding is robust against bit-flip errors that flip the system between state |0> and state |1> due to the stable nature of the dynamics that converges to the two states. The encoding does not correct the other error channel, that is, phase-flip errors. However, an additional error correcting scheme may be added to treat this separately. This stabilization is made possible by coupling to an extra mode and by engineering a 2-to-1 photon conversion between the first mode and the second mode.

In the diagrams of FIGS. 3, 6, and 9, simply the circuit 100 will be described. The coupling to the load, the microwave source driving the buffer, and the microwave source driving the ATS for parametric pumping are voluntarily not shown for simplicity's sake.

FIG. 3 represents an electrical equivalent diagram of a first embodiment of the galvanic cat circuit 100 of FIG. 1.

Circuit 100 comprises a non-linear resonant portion 30 and a linear resonant portion 32. Non-linear portion comprises an ATS 34 and a capacitive element 302. The non-linear resonant portion 30 and linear resonant portion 32 are galvanically connected together. In order to avoid any misunderstanding, the expression “galvanically coupled” means that there are short electrically conducting portions which connect the non-linear resonant portion 30 and the linear resonant portion, i.e., a short electrically conducting track or any other mean ensuring a physically continuous conducting junction. The expression “short” means that the electrically conducting track has an impedance which is negligeable compared to the impedance of the non-linear resonant portion 30 and the linear resonant portion 32 at the frequencies fa and fb. If this electrically conducting track has a non negligeable impedance, it will act as a voltage divider reducing the zero-point fluctuations φₐ and φ_{b} of the first and second resonant modes in the ATS, which is contrary to the aim of the description herein. In the example described here, the electrically conducting track is also arranged so that it does not shunt any of the non-linear and linear resonant portions.

In the given embodiment described herein, the non-linear resonant portion 30 comprises the ATS 34 and the capacitive element 302 which are connected in series. The linear resonant portion 32 comprises an inductive element 320 and a capacitive element 322 which are connected in parallel. If the non-linear resonant portion 30 (respectively linear resonant portion 32) was isolated from the rest of the circuit 100, it would host a first bare mode (respectively second bare more).

This galvanic circuit is minimal in the sense that its symbolic representation has the least possible number of elements to host two resonant modes (two capacitive elements 302 and 322, and two inductive elements 34 and 320). This is opposed to the state-of-the-art where the non-linear portion is coupled to the linear portion through a capacitive or inductive coupler, which leads to one resonant mode having a much lower participation in the ATS, hence lower zero-point fluctuations and a lower 2-to-1 photon conversion rate g₂. Since the minimal galvanic circuit proposed herein has a symbolic representation without such couplers, both resonant modes are expected to have large participations in the ATS. Although it may seem that the ATS 34 is capacitively coupled through the capacitor 302 to the linear bare mode, in fact, because it resonates with capacitor 302, they form the non-linear bare mode which is galvanically coupled to the linear bare mode.

This minimal galvanic circuit is also advantageous because it allows straightforward, simple, and compact realizations, as will be seen later.

Furthermore, it is to be noted that having one series resonant portion and one parallel resonant portion is the primary possible circuit topology. Thus, there exists specifically two possible minimal realizations of the circuit including an ATS, the one where the ATS is playing the role of the inductive element of the series resonant portion, as shown in FIG. 3, and the one where the ATS is playing the role of the inductive element of the parallel resonant portion, as will be shown in FIG. 6.

Using Lₚₐᵣₐₗₗₑₗ and Cₚₐᵣₐₗₗₑₗ as the values of, respectively, the inductive and capacitive elements of the parallel resonant portion, and Lₛₑᵣᵢₑₛ and Cₛₑᵣᵢₑₛ as the values of, respectively, the inductive and capacitive elements of the series resonant portion, these bare modes can be described:

by their angular frequencies ωₚₐᵣₐₗₗₑₗ=1/\sqrt{/L_{parallel,eff}*Cₚₐᵣₐₗₗₑₗ}) and wₛₑᵣᵢₑₛ=1/\sqrt{Lₛₑᵣᵢₑₛ*Cₛₑᵣᵢₑₛ}) with

$${L}_{parallel , eff} = {L}_{parallel} and {L}_{series , eff} = \frac{{L}_{series} {L}_{parallel}}{{L}_{series} + {L}_{parallel}}$$

by their impedances Zₚₐᵣₐₗₗₑₗ=\sqrt{L_{parallel,eff}/Cₚₐᵣₐₗₗₑₗ} and Zₛₑᵣᵢₑₛ=\sqrt{L_{series,eff}/Cₛₑᵣᵢₑₛ}, or equivalently

by their bare zero-point fluctuations parallel φ_{parallel,0}=\sqrt{π*Zₚₐᵣₐₗₗₑₗ/R_{q}}) and φ_{series,0}=\sqrt{π*Zₚₐᵣₐₗₗₑₗ/R_{q}}), where R_{q}=h/4e² is the superconducting resistance quantum.

In the case of FIG. 3 (respectively FIG. 6), Lₛₑᵣᵢₑₛ=Lₐₜₛ (respectively Lₚₐᵣₐₗₗₑₗ=Lₐₜₛ), where the inductance Lₐₜₛ is the effective inductance value of the ATS 34 in the vicinity of the global minimum of its potential energy. At the saddle point, the effective inductance Lₐₜₛ is equal to the shunt inductance of the ATS 34.

The linear part of the Hamiltonian of the galvanic circuit reads:

$${H}_{lin} = {w}_{a 0} {a}_{0}^{†} {a}_{0} + {w}_{b 0} {b}_{0}^{†} {b}_{0} + g ( {a}_{0} + {a}_{0}^{†} ) ( {b}_{0} + {b}_{0}^{†} ) ,$$

where the coupling rate is g=\sqrt{wₐ₀*w_{b0}}*k, with the dimensionless coupling constant k=\sqrt{Lₚₐᵣₐₗₗₑₗ/(Lₚₐᵣₐₗₗₑₗ+Lₛₑᵣᵢₑₛ)}.

The aforementioned modes a and b are the modes diagonalizing the Hamiltonian Hₗᵢₙ above. The dimensionless coupling constant k can take any value in between 0 and 1. A value close to 0 means weakly coupled modes while a value of 1 means maximally coupled modes. The minimal galvanic design is configured to easily reach values of k of about ½ or more. The possibility to reach such large coupling constants is specific to the field of superconducting circuits as was first shown in Devoret et al. “Circuit-QED: How strong can the coupling between a Josephson junction atom and a transmission line resonator be?”, Ann. Phys. 519, 767-779 (2007).

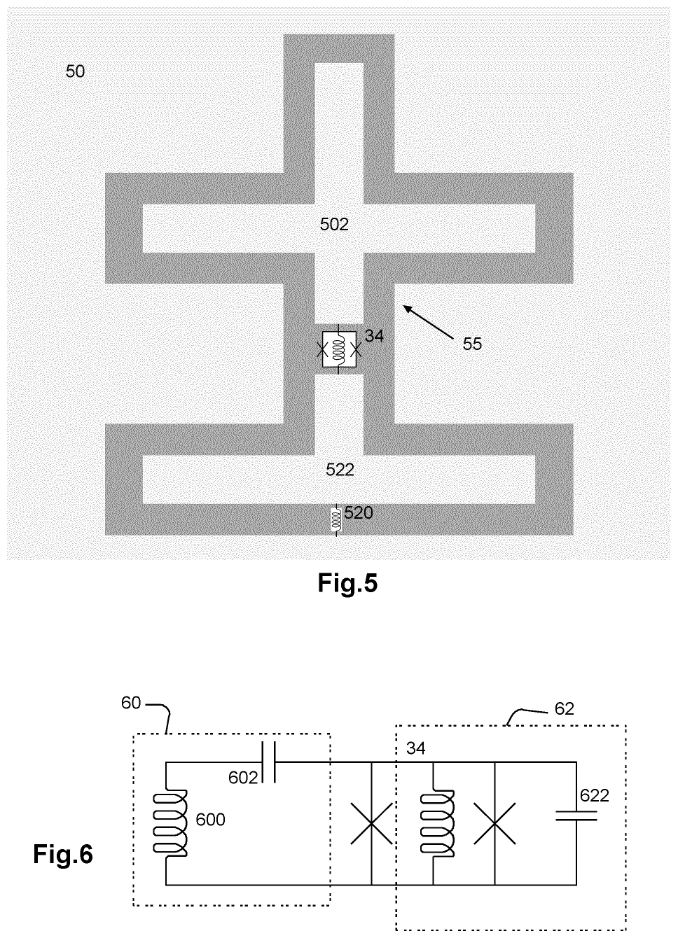

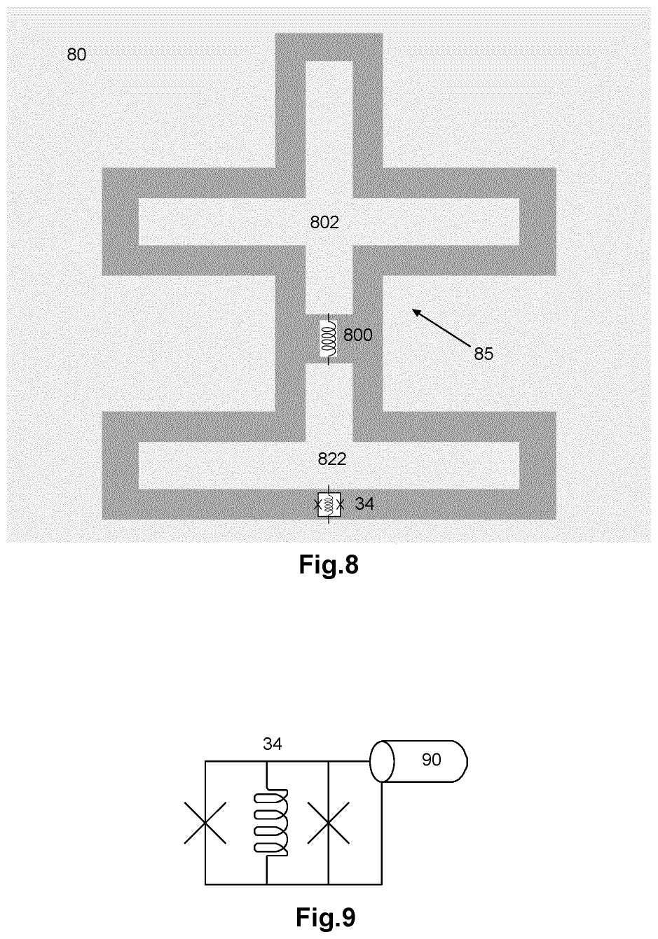

As will be shown in additional detail with regards to FIGS. 5 and 8, the inductive element and capacitive element form an LC resonator which may be implemented by distributed elements in the patterned layer of the superconducting material, such as:
two neighboring plates forming a capacitor in parallel with a superconducting wire, a single Josephson junction or an array of Josephson junctions forming an inductor:
a portion of superconducting transmission line which ends with two different boundary conditions (shorted to ground at one end and open at the other) forming a so-called λ/4 resonator. The transmission line being for example of the coplanar waveguide type or the microstrip type: or
a portion of superconducting transmission line which ends with two identical boundary conditions (open-open or short-short) forming a so-called λ/2 resonator, the transmission line being for example of the coplanar waveguide type or the microstrip type.

The ATS 34 is realized as known in the art, for example in the article Lescanne 2020. It is a structure with two Josephson junctions in parallel, with an inductive element in parallel between them. As a result, the ATS 34 comprises two connected loops, each loop comprising a Josephson junction in parallel with the shunt inductive element. The ATS 34 has both of its loops flux biased in DC and AC. The DC bias sets the working point of the ATS. It may be operated near the so-called saddle point, which is a sweet spot in frequency and has small cross-Kerr terms. The AC flux bias corresponds to the parametric pump at 2fₐ-f_{b}. This AC flux bias is usually chosen to drive the common mode of the two loops.

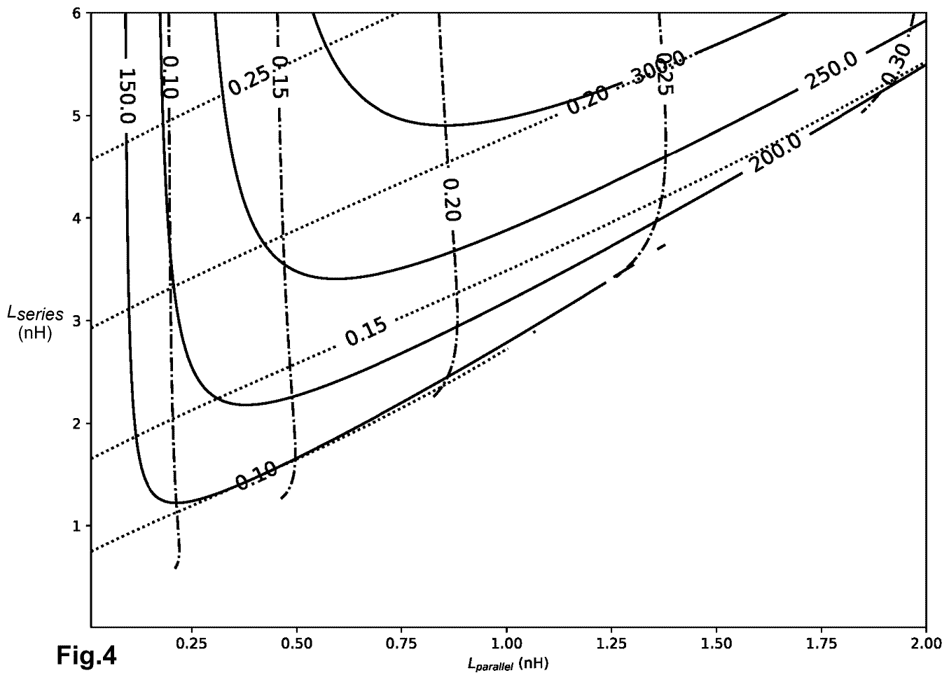

FIG. 4 shows the results of g₂/φₚ value curves which can be obtained for various values of the inductive element 320 (Lₚₐᵣₐₗₗₑₗ) and the inductance of the ATS 34 (Lₛₑᵣᵢₑₛ). On this figure, the value φₐ for the first mode is shown in radian as a dotted line, the value of φ_{b} for the second mode is shown in radian as a dashed-dotted line, and corresponding g₂/φₚ level lines are shown in MHz in full. These curves are established by fixing the first resonant frequency to 4.5 GHZ and the second resonant frequency to 8.0 GHZ, and by varying the value of inductive element 320 as easting, and the value of inductive element 34 as northing, while choosing the values of the capacitive elements 302 and 322 to obtain the above mentioned frequencies.

The reason for plotting the ratio g₂/φₚ is that φₚ is proportional to the amplitude of the parametric flux pump which is set by the amplitude of the microwave source 102, which is somehow arbitrary. On the contrary, the ratio

$$\frac{{g}_{2}}{{φ}_{p}} = 0.5 * {E}_{j} * {φ}_{a}^{2} * {φ}_{b}$$

depends specifically on intrinsic parameters of the circuit 100. FIG. 4 is calculated by assuming the ATS 34 is operated at its saddle point. In this case, the values of φₐ, φ_{b}, wₐ and w_{b} depend specifically on the inductance Lₐₜₛ of the ATS and are independent of Lⱼ. Since the Josephson energy Eⱼ reads

$${E}_{j} = \frac{{φ}_{0}^{2}}{{L}_{j}} ,$$

it sounds like one can make g₂/φₚ arbitrarily large by ever decreasing Lⱼ. However, the ATS dynamics becomes more instable as the ratio Lₐₜₛ/Lⱼ is increased (as evidenced in the article by Burgelman et.al. “Structurally stable subharmonic regime of a driven quantum Josephson circuit”, https://arxiv.org/abs/2206.14631). In FIG. 4, this ratio is set to Lₐₜₛ/Lⱼ=2, which corresponds to the value in Lescanne 2020.

This figure shows that, for conventional values of inductive elements 34 and 320, values of g₂/φₚ of over 250 MHz can easily be attained. In effect, the works by the Applicant have shown that values over 100 MHz are guaranteed, which is an order of magnitude over the known prior art, and that values of several hundred MHz can be achieved. In comparison, the value of g₂/φₚ achieved in Lescanne 2020 was 9.6 MHz. In Berdou 2022, it was at least 1 order of magnitude smaller than that.

FIG. 4 also shows the zero-point fluctuations φₐ and φ_{b}. Even though specifically the product

$${φ}_{a}^{2} * {φ}_{b}$$

matters for g₂, the actual values of φₐ and φ_{b} have a direct impact on the spurious terms generated by the ATS, which may, in turn, induce noise processes escaping the confinement of the stabilized coherent states.

Since the 2-to-1 photon conversion Hamiltonian relies on a third order expansion of the ATS potential energy in φₐ* (a+a^{†})+φ_{b}* (b+b^{†}), a rule of thumb known from the man skilled in the art is to keep φₐ*max(α, 1/2) and φ_{b}*max (β, 1/2) small compared to π. Here, α is the amplitude of the coherent state stabilized in the cat qubit and β is the amplitude of the residual electromagnetic field in the buffer.

The term ½ in max (α or β, ½) is used to account for the minimal zero-point fluctuations. With α=2, it is considered safe to keep φₐ<0.1. On the other hand, β tends to be very close to zero, so max (β, ½)=½. It means larger values of φ_{b} can be tolerated, typically φ_{b}<0.3. FIG. 4 shows that g₂ can be increased to more than one order of magnitude compared to the state-of-the-art while keeping safe values of the parameters.

FIG. 4 also shows that more aggressive values of φₐ and φ_{b} could be easily reached, resulting in a further increase of g₂. It should be noted that it is not known yet by how much da and φ_{b} can be pushed, since the cat qubit domain is quite recent and lacks such studies. The galvanic cat design, with its obvious potential to realize large φₐ and φ_{b}, will therefore allow to perform such studies.

FIG. 11 shows in full the ratio

$${( \frac{{φ}_{b , parallel}}{{φ}_{a , parallel}} )}^{2}$$

of the square of the zero-point fluctuations of modes b and a across the parallel portion, that is the parallel combination of the linear capacitor 322 and the linear inductor 320 of the linear resonant portion 32 in the case of FIG. 3. It also shows the ratio

$${( \frac{{φ}_{b , {C}_{series}}}{{φ}_{a , {C}_{series}}} )}^{2}$$

as dotted lines and the ratio

$${( \frac{{φ}_{b , {L}_{series}}}{{φ}_{a , {L}_{series}}} )}^{2}$$

as dash-dotted lines of the square of the zero-point fluctuations of modes b and a across the capacitor 302 and ATS 34, respectively, of the non-linear resonant portion 30. The decay rates of modes a and b in the load are proportional to the square of φ_{a/b,parallel}, φ_{a/b,C}_{ₛₑᵣᵢₑₛ} or φ_{a/b,L}_{ₛₑᵣᵢₑₛ}, if the load is coupled with the coupler 104 to, respectively, the parallel portion 320/322, the series capacitor 302 or the ATS 34. As can be seen, the ratios have at best a value of the order of 1 in the region of safe parameters. That is, the geometry of the quantum circuit completely hybridizes the memory and buffer modes such that a negligeable level of protection of the memory is provided from decay in the load 106. It is the price to pay for this galvanic cat circuit design with a minimal number of components.

Yet, thanks to the large value of the dimensionless coupling constant k, the first resonant frequency and the second resonant frequency can be spaced wide apart from each other (3.5 GHz in FIG. 4), thus giving a lot of room to the microwave filter 106 to strongly reject the field at the frequency of the first resonant mode.

Furthermore, it is also possible to choose the first resonant frequency and the second resonant frequency so that the pump frequency 2fₐ-f_{b} is somewhat far from both fₐ and f_{b}. For example. 2fₐ-f_{b} is made smaller than fₐ/2 and f_{b}/2. This can be obtained by choosing a buffer frequency f_{b} not too far from twice the memory frequency fa which results in a small pump frequency fₚ=2fₐ-f_{b}. For instance, the value of fₚ is 1 GHZ in FIG. 4, which is more than four times smaller than fₐ and eight times smaller than f_{b}.

It is advantageous because the first order term of the expansion of the ATS potential energy shows that the parametric pump can directly drive the circuit. As shown in the Supplementary Material of Lescanne 2020, this driving results in spurious dynamical AC Stark shift and dynamical cross-Kerr terms, which are detrimental to the cat qubit operations. With a low pump frequency, the direct driving of the circuit is much less efficient, which results in much smaller dynamical AC Stark shift and dynamical cross-Kerr.

Another advantage is that the value 2fₐ-f_{b} can be made distant from both fₐ and f_{b}, such that a second microwave filter could be introduced into the parametric pump line to prevent the first mode from leaking into the parametric pump line.

This is all the more surprising as, with such strongly hybridized modes, the possibility to have a low loss memory mode is highly counterintuitive. The rationale is that the field of quantum computing is quite young, especially in the cat qubit domain, and it is generally preferred to make very incremental changes. One of the reasons to have an ATS localized on the second mode and have the first mode weakly coupled capacitively to the second mode in Lescanne 2020 and Berdou 2022 is to minimize the decay of the first mode due to the decay of the second mode in the load. Indeed, conventionally, it is considered much preferable to couple the non-linear elements of the quantum circuit to a single mode and weakly couple other modes to it.

Galvanically coupling the non-linear element is manifestly not an incremental change and goes against all prejudices.

Finally, a large spacing in frequency in between fₐ and fb makes the design more robust to nanofabrication uncertainties, such as the well-known problem of the variability of the inductances of the various Josephson junctions in the circuit, which primarily affects the accuracy of the prediction of fₐ and f_{b}.

FIG. 5 shows a realization of the circuit of FIG. 3.

Similar elements have been given like reference numerals. Only the first number of the reference numeral will change from “3” to “5”, i.e., capacitive element 322 of FIG. 3 is referenced 522 on FIG. 5.

The figure is a top view of the layout of a superconducting chip designed by the Applicant to correspond to the circuit of FIG. 3. Light grey parts correspond to metallized surface with tantalum or aluminum. Grey parts correspond to the substrate made in sapphire on which the circuit lies. Other materials can be used to realize the superconducting circuit, for instance niobium, NbTi or TiN for the metallization and silicon or quartz for the chip.

The circuit comprises a ground plane 50, on which the circuit 55 is formed. The non-linear resonant portion comprises the ATS 34 and a capacitive element 502 which has a cross shape. The linear resonant portion 30 is formed by the bottom portion of this figure, a big rectangle forming the capacitive element 522, to which an array of Josephson junctions 520 forming an inductive element are connected.

Also not shown on FIG. 5, the coupler 104 could be realized advantageously, according to FIG. 11, by coupling capacitively a CPW transmission line to the electrode 522. Furthermore, the cat qubit could be coupled to another cat qubit or a readout transmon through CPW buses capacitively coupled to the different branches of the electrode 502. Capacitively coupling a CPW to an electrode such as 502 and 522 is routinely done with superconducting circuits. Finally, two CPW passing close to the respective sides of the ATS 34 could be used to flux bias it, both in DC to set its working point and in AC to realize the parametric pump.

The circuit of FIG. 5 shows a lumped and grounded realization of the resonant modes of the circuit of FIG. 1. This design is said to be lumped because the total size of the circuit 100 is shorter than the quarter-wavelength the first mode and the second mode. This design is said to be grounded because the first mode and the second mode correspond to oscillations of charge and current in between electrodes and the ground plane 50 to which they are galvanically coupled through the ATS 34.

Other realization of the inductors could be possible, for instance geometric inductors made of meandered or spiraled lines.

This grounded design is more sensitive to the imperfections of the ground plane and may experience more crosstalk than differential designs, but it is much more compact and minimize parasitic capacitances that may shunt the ATS and therefore alter the accuracy of the symbolic representation in FIG. 3. The simplicity and symmetry of this design illustrates the effectiveness of the galvanic cat circuit with a minimal number of components.

In another embodiment, the design could be differential, meaning that the first mode and the second mode correspond to oscillations of charge and current in between pairs of electrodes, which are galvanically isolated from the ground plane 50. Differential designs occupy more space than grounded designs, but they have the advantage of offering a better isolation to the lossy components of the ground place, such as the wire bonds (not shown on the drawings), or other components that may be patterned on the chip, such as other cat qubits, and thus reduce crosstalk.

FIG. 6 represents a second embodiment, which is similar to that of FIG. 3. The main difference is that the non-linear resonant portion 62 elements are now in parallel, whereas they were in series in the embodiment of FIG. 3. Similarly, the elements of linear resonant portion 60 are now in series, whereas they were in parallel in the embodiment of FIG. 3.

Similar elements have been given like reference numerals. Only the first number of the reference numeral will change from “3” to “6”, i.e., capacitive element 302 of FIG. 3 is referenced 602 on FIG. 6.

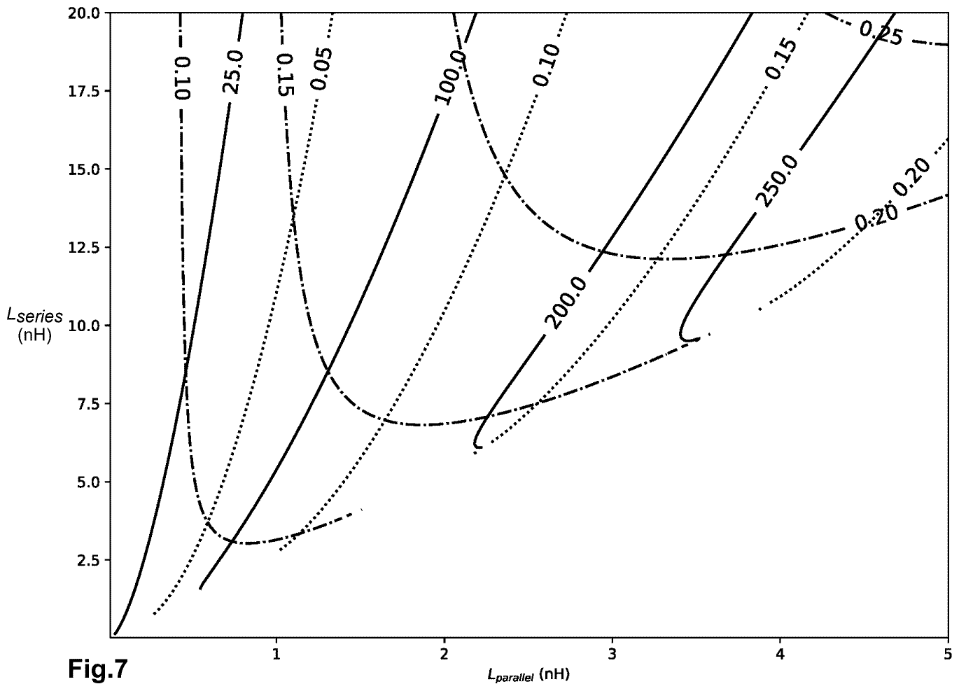

FIG. 7 is a figure similar to FIG. 4, but based on the circuit of FIG. 6. For simplicity's sake, it will not be described further. It is to be noted that FIG. 11 and its description remain quantitatively valid for the circuit of FIG. 6.

FIG. 8 shows a realization of the circuit of FIG. 6. It is similar to the realization of the circuit of FIG. 3 shown in FIG. 5, except for the linear inductance and ATS 34 that have been exchanged such that the linear and non-linear resonant portions have also been exchanged. This design is advantageous in that the ATS 34 is now galvanically coupled to the ground plane which allows an easier and larger coupling to the flux lines (not shown).

FIG. 9 shows a third embodiment of the galvanic cat circuit.

In the embodiment of FIG. 9, there is specifically one resonant portion which generates both the first mode and the second mode with the ATS 34. This embodiment is different from the embodiments of FIG. 3 and FIG. 6 in that the properties of the first resonant mode and of the second resonant mode are usually not accurately described with a simplified symbolic representation involving specifically two LC resonators. This exemplifies the reason why the present disclosure goes against the existing prejudices: while a low coupling constant k would allow for a good understanding of the first mode and the second mode from a simple perturbative analysis including specifically two bare modes of the resonant portion and the ATS, it cannot be so here, and more bare modes of the resonant portion have to be taken into account.

As shown on this figure, the ATS 34 is connected to an open-ended transmission line 90. This circuit is galvanic since the ATS is directly terminating the transmission line hosting the resonant modes. It can be realized in the same materials as the elements of FIG. 5. If the characteristic impedance of the transmission line required to reach a given Ob or Pa is too large to be made geometrically, the center conductor of the transmission line could be replaced by a high kinetic inductance material or a chain of wide Josephson junctions. Finally, the transmission line could be realized with various geometries, for instance coplanar waveguide (CPW), microstrip or slotline. In the example of FIG. 9, CPW 90 could be capacitively or inductively connected to the microwave filter 110 and the load 106 for coupling to the environment.

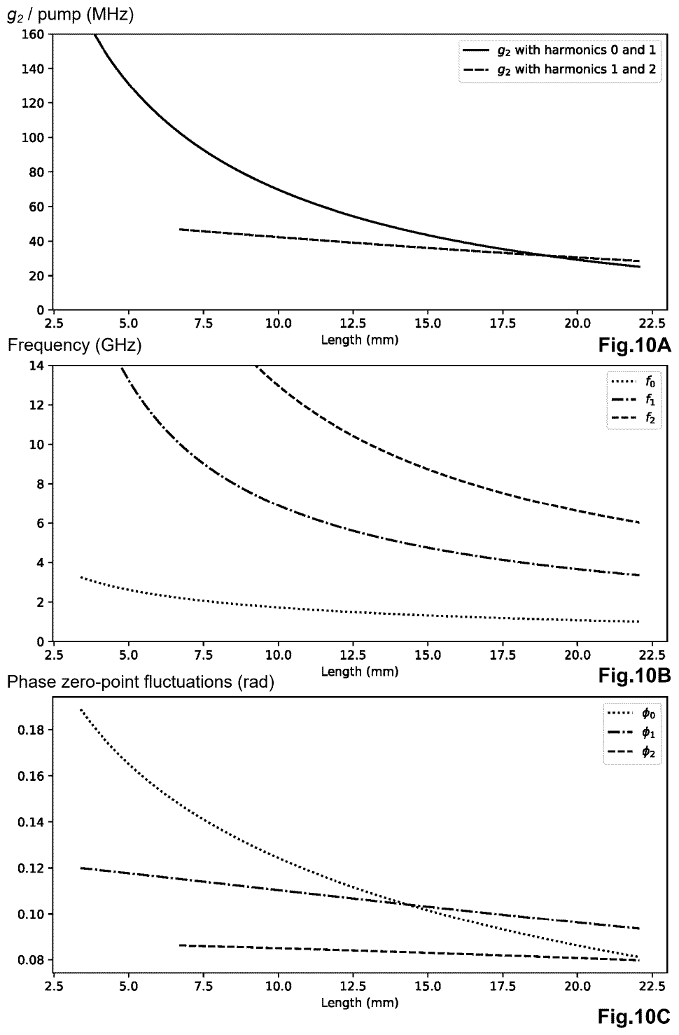

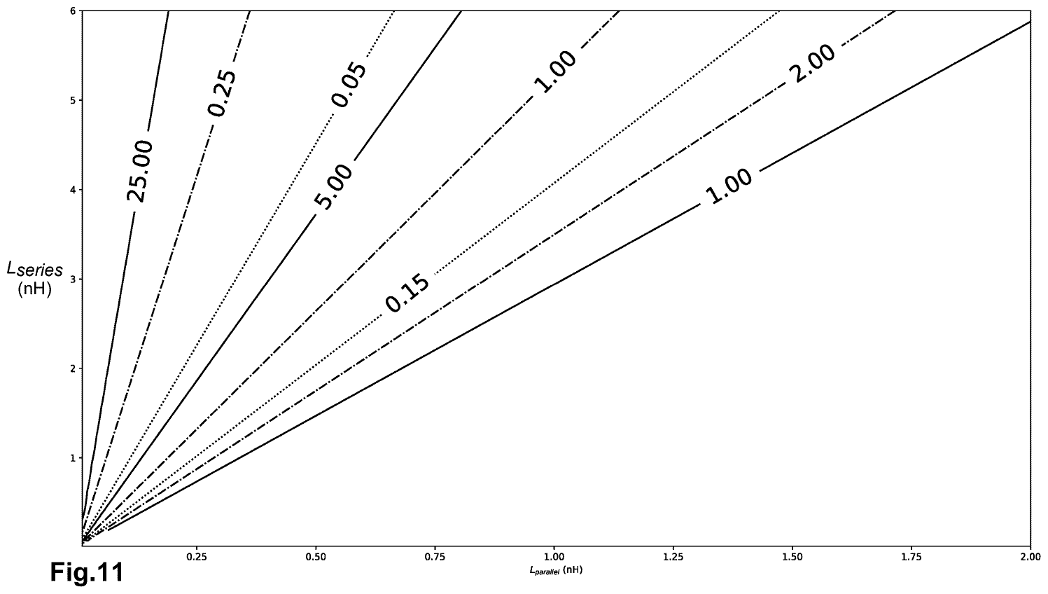

FIGS. 10A, 10B, and 10C are somewhat similar to FIGS. 4 and 7, with the difference that the FIG. 10 series takes into account that, due to the realization of a transmission line, several harmonics have to be taken into account. As a result, there are three graphs of FIG. 10, namely FIGS. 10A, 10B, and 10C, which describe the behavior of the transmission line harmonics 0, 1 and 2.

In FIG. 10A, 10B, and 10C, the ATS parameters are the same as in FIGS. 4 and 7. The CPW is assumed to have a characteristic impedance of 50 Ω and, without loss of generality, an effective relative permittivity ϵᵣ=5.6, typical for CPW on sapphire, is taken.

The graph shown in FIG. 10A represents the results of g₂/φₚ which can be obtained for various lengths of the CPW. The full line corresponds to a 2-to-1 photon rate g₂/φₚ calculated with the first resonant mode (respectively second resonant mode) taken as the first (or fundamental) harmonics (respectively second harmonics) of the non-linear quantum circuit, in which case the first resonant mode index a=0) and the second resonant mode index b=1. The dashed line corresponds to a 2-to-1 photon rate g₂/φₚ calculated with the first resonant mode (respectively second resonant mode) taken as the second harmonics (respectively third harmonics) of the non-linear quantum circuit, in which case the first resonant mode index a=1 and the second resonant mode index b=2.

On the graph shown in FIG. 10B, the values f₀, f₁ and f₂ of the frequencies of the respectively first (or fundamental), second and third harmonics are represented in GHz.

On the graph shown in FIG. 10C, the values φ₀, φ₁ and φ₂ of the zero-point fluctuations of the phase across the ATS 34 of the respectively first (or fundamental), second and third harmonics are represented in radian.

Contrary to FIG. 4 and FIG. 7, it is necessary to show the first resonant frequency and the second resonant frequency variation as they are not fixed. It appears that large detunings f_{b}-fₐ of several GHz can be reached, as well as values of g₂/φₚ well beyond the state-of-the-art for safe values of φₐ and φ_{b}.

It is obvious to the man skilled in the art that it is possible to adjust the values of fₐ, f_{b}, φₐ, φ_{b} and g₂/φₚ in order to fit a given application by tweaking, for instance, the characteristic impedance of the transmission line, or using other harmonics. It is also possible to change the termination of the transmission line, though some terminations, for instance an inductive short, have to be included in the potential energy of the ATS and, as a consequence, would modify its working point and dynamics.

1. Non-linear superconducting quantum circuit comprising at least one resonant portion (30,32;60,62) and an asymmetrical threaded superconducting quantum interference device (34) connected galvanically, said non-linear superconducting quantum circuit having a first mode (a) with a first resonant frequency and a second mode (b) with a second resonant frequency, the ratio between said first resonant frequency and said second resonant frequency being different from 1/2, said at least one resonant portion (30,32;60,62) having a symbolic representation comprising a linear resonant portion (32;60) comprising at least one inductance (320;600) and at least one capacitor (322;602) and a non-linear resonant portion (30;62) comprising at least one capacitor (302;622) and said asymmetrical threaded superconducting quantum interference device (34), said linear resonant portion (30) and non-linear resonant portion (32) being connected galvanically and arranged respectively such that one has its elements connected in series, and the other one has its elements connected in parallel, said at least one resonant portion (30,32) being configured with inductance and capacitance values which induce with said asymmetrical threaded superconducting quantum interference device (34) said first mode (a) and said second mode (b) such that said non-linear superconducting quantum circuit (100) has zero-point fluctuations of the superconducting phase across the asymmetrical threaded superconducting quantum interference device (34) for the first mode (a) and the second mode (b) which are superior or equal to 0.05 rad.

2. Non-linear superconducting quantum circuit according to claim 1, wherein said linear portion (32) comprises elements arranged in parallel and said non-linear portion (30) comprises elements arranged in series.

3. Non-linear superconducting quantum circuit according to claim 1, wherein said linear resonant portion (60) comprises elements arranged in series and said non-linear resonant portion (62) comprises elements arranged in parallel.

4. Non-linear superconducting quantum circuit according to claim 2 or 3, wherein said non-linear superconducting quantum circuit lies on a dielectric substrate and is delimited from a common ground plane (50;80) by exposed portions of said dielectric substrate, and said linear resonant portion and said non-linear resonant portion are realized in physically distinct portions of said non-linear superconducting quantum circuit.

5. Non-linear superconducting quantum circuit according to claim 4, wherein said non-linear superconducting quantum circuit is formed on a substantially planar substrate and has a width and a height which are both shorter than the quarter wavelength corresponding to said first resonant frequency and shorter than the quarter wavelength corresponding to said second resonant frequency.

6. Non-linear superconducting quantum circuit according to claim 4 or 5, wherein said non-linear resonant portion and said linear resonant portion are galvanically connected to said common ground plane (50;80).

7. Non-linear superconducting quantum circuit according to claim 4 or 5, wherein said non-linear resonant portion and said linear resonant portion are galvanically isolated from said common ground plane.

8. Non-linear superconducting quantum circuit according to claim 1, wherein said non-linear superconducting quantum circuit lies on a dielectric substrate and is delimited from a common ground plane by exposed portions of said dielectric substrate, and said at least one resonant portion is realized into a transmission line (90).

9. Non-linear superconducting quantum circuit according to claim 8, wherein the first mode (a) and the second mode (b) are of respective fundamental or higher order harmonics of said non-linear superconducting circuit (100).

10. Non-linear superconducting quantum circuit according to one of the preceding claims, wherein the first resonant frequency and the second resonant frequency are such that the difference between two times the first resonant frequency and the second resonant frequency is smaller than half the first resonant frequency and half the second resonant frequency.

11. Non-linear superconducting quantum circuit according to claim 8 or 9, wherein said transmission line (90) is made by an array of Josephson junctions or a high kinetic inductance material.

12. Non-linear superconducting quantum circuit according to one of the preceding claims, wherein said at least one inductance (320;600) is made by an array of Josephson junctions or a high kinetic inductance material.

13. Quantum device comprising a non-linear superconducting quantum circuit according to one of the preceding claims, a first microwave source (108) connected to said at least one resonant portion (30,32;60,62;90) for providing a radiation having a frequency equal to said second resonant frequency, a second microwave source (102) connected to said at least one resonant portion (30,32;60,62;90) for providing a radiation having a frequency equal to the difference between two times the first resonant frequency and the second resonant frequency, and a load (106) coupled to said at least one resonant portion (30,32;60,62; 90) such that only the second mode (b) is coupled to said load (106), said first mode (a) thereby hosting a cat qubit.

14. Quantum device according to claim 13, further comprising a microwave filter (110) for coupling to said load (106), said microwave filter (110) being arranged to let the second resonant frequency pass and to block the first resonant frequency.

15. Quantum computing system comprising at least one device according to claim 13 or 14.
